(19) United States
(12) Patent Application Publication
(10) Pub. No.: US 2025/0050386 A1
(43) Pub. Date: Feb. 13, 2025

(54) METHOD OF CLEANING RELAYS

(71) Applicant: Sung-Jen Wu, New Taipei City (TW)

(72) Inventor: Sung-Jen Wu, New Taipei City (TW)

(21) Appl. No.: 18/231,777

(22) Filed: Aug. 8, 2023

(51) Int. Cl. B08B 7/00; B08B 5/02; B08B 7/04; B08B 15/02; B23K 26/142; B23K 26/362; H01H 1/00

(52) U.S. Cl. CPC B08B 7/0042; B08B 5/02; B08B 7/04; B08B 15/02; B23K 26/142; B23K 26/362; H01H 1/00; B08B 2215/003

(57) ABSTRACT

The present invention relates to a method of cleaning relays. The method includes: a loading step by placing a relay on a feeding platform of a machine and directing a laser processing head of the machine to allow emission of laser light towards the relay; and a surface treatment step by activating the laser processing head to perform laser surface treatment on a portion of the relay to be treated. The present invention provides operators with a fast, time-saving, and efficient method for processing a large number of relays requiring surface treatment. It aims to improve upon the conventional electrolytic surface treatment techniques that are labor-intensive, time-consuming, and may have certain impacts on human health and the environment.

### BACKGROUND OF THE INVENTION

### Fields of the Invention

The present invention relates to a method of cleaning relays, and more particularly, to that applied in the field of relays to mainly clean terminals of metal portions of the relays, significantly reducing the operational time and minimizing the costs associated with manual labor.

### Descriptions of Related Art

Relays are essential electronic components for general machinery, circuits and the like, and have a control system and a controlled system. Relays typically are used in automatic control circuits, and act as “automatic switches” utilizing a smaller current to control a larger current. Within circuits, relays play roles in automatic regulation, safety protection, and circuit switching.

Further, the relay has a portion, so called “contact” or “terminal”, mainly responsible for providing electrical connections with machinery and circuit boards and primarily made of metal. Metals are particularly susceptible to oxidation when exposed to ambient air or foreign substances, resulting in deterioration of the metal surface. When metal portions begin to oxidize, resulting in the formation of contact spots, impedance is generated during contact, affecting the efficiency and energy of the electrical transmission. Upon the metal portions of the relay show signs of oxidation, manufacturers usually disassemble them and perform surface treatment using electrolysis. However, this surface treatment via electrolysis is time-consuming, labor-intensive, and becomes impractical when a large number of relays require surface treatment. Additionally, the extensive use of electrolyte not only incurs high costs, but also involves health and environmental concerns.

### SUMMARY OF THE INVENTION

The primary objective of the present invention is to provide operators with a fast, time-saving, and efficient method for processing a large number of relays requiring surface treatment. It aims to improve upon the conventional electrolytic surface treatment techniques that are labor-intensive, time-consuming, and may have certain impacts on human health and the environment. To this end, the present invention provides a method of cleaning relays to achieve the aforementioned purposes and benefits, the method including: a loading step by placing a relay on a feeding platform of a machine and directing a laser processing head of the machine to allow emission of laser light towards the relay; and a surface treatment step by activating the laser processing head to perform laser surface treatment on a portion of the relay to be treated.

Based on the aforementioned description of the present invention, the method has advantages of significant increase in the speed of surface treatment for a large number of relays using laser energy and more thorough removal of oxidation from the interior of the relay through the laser processing under a laser processing head by placing a relay on a feeding platform and performing laser processing on portions of the relay to be surface treated under the laser processing head.

### BRIEF DESCRIPTION OF THE DRAWINGS

FIG. 1 is a schematic diagram of the process flow in the present invention.

FIG. 2 is a schematic block diagram for illustration of the structural design of the present invention.

### DETAILED DESCRIPTION OF THE PREFERRED EMBODIMENT

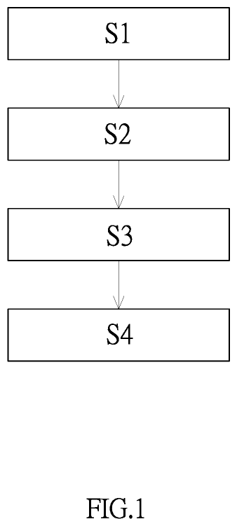

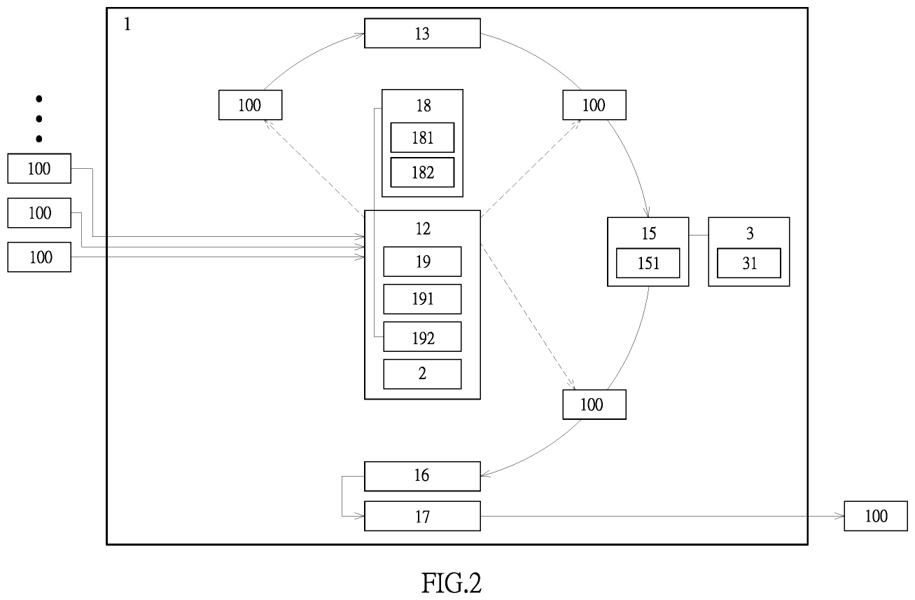

Please referring to FIG. 1 and FIG. 2, the present invention provides a method of cleaning relays. The method of the present invention includes a loading step S1 by placing a relay 100 on a feeding platform 12 of a machine 1. The relay 100 positioned on the feeding platform 12 is an internally unassembled semi-finished product with only its casing and internal metal components (contacts, terminals).

Continuing from the previous step, the method proceeds to a surface treatment step S2: after the relay 100 is placed on the feeding platform 12, the feeding platform 12 rotates to move the relay 100 under a laser processing head 13. The laser processing head 13 performs laser surface treatment on the portions of the relay 100 to be processed. The portions to be processed are oxidized metal portions. Additionally, while the feeding platform 12 is rotating, another relay 100 can be loaded for subsequent surface treatment. Subsequently, a cleaning step S3 is performed: once the surface treatment in the step S2 is completed, the feeding platform 12 continues to rotate, causing another as-loaded relay 100 on the feeding platform 12 to move under the laser processing head 13. Meanwhile, the relay 100 that has undergone surface treatment is moved under a hood 15. The hood 15 moves downward to fully cover the relay 100, and within the hood 15, gas is jetted onto the surface-treated portions of the relay 100 to remove any residues. Finally, the method proceeds to a back-end clamping step S4: after the cleaning of the relay 100 by the hood 15 in the cleaning step S3 is finished, the hood 15 is lifted upward and does not cover the relay 100, followed by moving the cleaned relay 100 via the feeding platform 12 to a position corresponding to a clamping arm 16 disposed within the machine 1. The clamping arm 16 grips and moves the cleaned relay 100 to an exit conveyor platform 17 of the machine 1. The exit conveyor platform 17 utilizes its transmission mechanism to convey the cleaned relay 100 outside the machine 1 for collection.

According to the aforementioned description, the present invention utilizes the feeding platform 12 for delivery of the relay 100, allowing for efficient surface treatment of a large number of relays 100 in the shortest time. Additionally, the use of the laser processing head 13 accelerates the processing time compared to the conventional method of surface treatment using electrolyte, which is not only time-consuming but also wasteful and environmentally detrimental. By the configuration of the machine 1 in combination with the mechanical components used in each step, the present invention enables rapid surface treatment of a large number of relays 100 and ensures that the metal portions of the cleaned relays 100 maintain a smooth and shiny appearance. More importantly, the removal of oxidized portions improves the electrical conductivity between the relays 100 and other components. As such, after the surface treatment of the relay 100, the molecules not originally present on the metal portions can be removed, thereby reducing contact resistance by 50% mΩ. Additionally, due to low-intensity laser light emitted from the laser processing head 13 utilized during the surface treatment in the present invention, the metal portions of the relay 100 after cleaning can maintain low contact resistance and exhibit improved conductivity by breaking through the oxide film layer on the metal portions. The rotation of the feeding platform 12 inside the machine 1 to control the transfer of the relay 100, along with the utilization of the clamping arm 16, the laser processing head 13 and the hood 15, reduces the workload for personnel. The surface treatment operation of a large number of relays 100 can be completed by only one or a few operators, effectively achieving cost savings, as illustrated in FIGS. 1 and 2.

After explaining the main technical aspects of the present invention, other technical features will be discussed in detail hereafter. As shown in FIGS. 1 and 2, in order to prevent the generation of residues during the surface treatment step S2 performed by the laser processing head 13, a gas nozzle assembly 18 is further provided on the machine adjacent to the laser processing head 13. The gas nozzle assembly 18 includes one or more jet tubes 181 (e.g. two jet tubes 181 depicted in the figure) and an equal number of jet heads 182, corresponding to the number of jet tubes 181. Each of the jet tubes 181 has one end connected to a gas source (e.g., a gas pressure pump) and the other end assembled with the corresponding jet head 182. The jet heads 182 are directed towards the laser processing head 13 and configured to jet gas onto the relays 100 located under the laser processing head 13 to remove residues during the surface treatment step S2.

To ensure that the jetting from the jet tubes 181 is appropriately directed without excessive jetting force that might cause the jet tubes 181 to misalign, as shown in FIG. 2, a perforation 19 is further provided in the feeding platform 12. The machine 1 includes an axle frame 191 that has one end extending through the perforation 19 of the feeding platform 12 along a direction towards the laser processing head 13 to form a support platform 192. The jet tubes 181 are movably positioned on the support platform 192 and secured using binding straps or ropes (not shown in the figure). The movable positioning between the jet tubes 181 and the support platform 192 is not limited to the manner described above, as long as misalignment of the jet tubes 181 can be avoided. Continuing with FIG. 2, to ensure stable placement of the relays 100 to prevent shifting after the emission of laser from the laser processing head 13 towards the relays 100, the feeding platform 12 is further equipped with a plurality of holders 2 thereon. Each relay 100 is placed on a respective holder 2, and the clamping arm 16 grips the relay 100 off from the respective holder 2. As shown in FIG. 2, the relay 100 is inserted into the respective holder 2 using its terminals, and the portions to be surface treated are at contact positions internal to the relay 100.

In addition, during the cleaning step S3, the purpose of the hood 15 is mainly to prevent debris from scattering and affecting the surface treatment of other relays 100 while cleaning residues from one relay 100. Within the hood 15, a high-pressure sprayer 151 is further installed to perform high-pressure jetting after fully covering the relay 100. The high-pressure sprayer 151 removes residues from inside the relay 100. By using the hood as a cover, the splattering of residues can be avoided during the jetting process. However, to prevent residues from affecting other operations due to other factors, the machine 1 of the present invention further includes a suction device 3 and an exhaust pipe 31 having one end connected to the suction device 3 and the other end connected to and internally communicated with the hood 15. While the high-pressure sprayer 151 performs high-pressure jetting on the relay 100, the suction device 3 operates and sucks gas from inside the hood 15 through the exhaust pipe 31, collecting residues sprayed by the high-pressure sprayer 151 inside the hood 15. By using the suction device 3, the residues can be efficiently managed during the cleaning step S3, making it convenient and time-saving for users. The need for manual cleaning is eliminated, and users can simply empty the collected residues, as shown in FIGS. 1 and 2.

In summary, the operation of the present invention is user-friendly, and users can handle the surface treatment of a large number of oxidized relays 100 without the need for manual operation once the machine 1 is set up. The metal portions of the relays 100 after the surface treatment can maintain low contact resistance and exhibit excellent conductivity. Compared to the conventional treatment using electrolyte, the present invention achieves significant results in a shorter time and reduces the reliance on human labor, making it more practical.

1. A method of cleaning a relay, the method including:
a loading step: placing a relay on a feeding platform of a machine, and directing a laser processing head of the machine to allow emission of laser light towards the relay; and
a surface treatment step: activating the laser processing head to perform laser surface treatment on a portion of the relay to be treated, a low-intensity laser light emitted from the laser processing head utilized during the surface treatment, and
a cleaning step: moving the surface-treated relay under a hood and moving the hood downward to fully cover the relay and within the hood jetting gas onto surface-treated portions of the relay, wherein a high-pressure sprayer is disposed within the hood in the cleaning step to allow high-pressure jetting after the relay is fully covered by the hood, so as to enable removal of residues from inside the relay and block splattering of the residues by the hood, the machine includes a suction device and an exhaust pipe, the exhaust pipe has one end connected to the suction device and the other end connected to and internally communicated with the hood, while the high-pressure sprayer performs high-pressure jetting on the relay, the suction device operates and sucks gas from inside the hood through the exhaust pipe to collect the residues sprayed by the high-pressure sprayer inside the hood.

2. (canceled)

3. The method of cleaning a relay as claimed in claim 2, the method further comprising a back-end clamping step after the cleaning step: after cleaning of the relay by the hood in the cleaning step is completed, moving the cleaned relay to a position corresponding to a clamping arm and gripping and moving the cleaned relay by the clamping arm to an exit conveyor platform of the machine.

4. The method of cleaning a relay as claimed in claim 3, wherein the feeding platform is further equipped with at least one holder thereon to allow the relay to be placed on the at least one holder, and the feeding platform is rotatable, enabling cyclic movement of the at least one holder among positions corresponding to the laser processing head, the hood and the clamping arm, respectively, and the clamping arm is configured to grip the relay off from the respective one of the at least one holder and place the relay on the exit conveyor platform.

5. The method of cleaning a relay as claimed in claim 1, wherein:
the machine is further provided with a gas nozzle assembly adjacent to the laser processing head;
the gas nozzle assembly includes a jet tube and a jet head;
the jet tube has one end connected to a gas source and the other end assembled with the jet head; and
the jet head is directed towards the laser processing head and is configured to jet gas onto the relay located under the laser processing head to remove residues during the surface treatment step.

6. The method of cleaning a relay as claimed in claim 5, wherein:
the feeding platform is further provided with a perforation;
the machine further includes an axle frame that has one end extending through the perforation of the feeding platform along a direction towards the laser processing head to form a support platform; and
the jet tube is movably positioned on the support platform.

7. (canceled)

8. (canceled)
